(19) United States
(12) Patent Application Publication
(10) Pub. No.: US 2024/0072366 A1
(43) Pub. Date: Feb. 29, 2024

(54) ELECTRICAL APPARATUS

(71) Applicant: Koki Holdings Co., Ltd., Tokyo (JP)

(72) Inventors: Hideyuki TANIMOTO, Ibaraki (JP); Nobuhiro TAKANO, Ibaraki (JP); Masashi TAKEHISA, Ibaraki (JP)

(73) Assignee: Koki Holdings Co., Ltd., Tokyo (JP)

(21) Appl. No.: 18/269,950

(22) PCT Filed: Dec. 17, 2021
(86) PCT No.: PCT/JP2021/046846

§ 371 Date: Jun. 27, 2023

(30) Foreign Application Priority Data
Mar. 31, 2021 (JP) 2021-061186

(51) Int. Cl. H01M 50/296; H01M 10/42; H02J 7/00

(52) U.S. Cl. CPC H01M 50/296; H01M 10/425; H02J 7/0024; B25F 5/02

(57) ABSTRACT

A 36V electrical apparatus is mountable with both an 18V/36V switchable battery pack and an 18V battery pack. In the case where the 18V/36 V battery pack is connected to the 36V electrical apparatus, first switches are turned off and a second switch is turned on to connect the battery pack in series (36V output). In the case where the 18V battery pack is connected to the 36V electrical apparatus, the first switches are turned on and the second switch is turned off to generate an 18V output, thus making it possible to mount the 18V battery pack to the 36V electrical apparatus. Furthermore, the voltage of the mounted battery pack is determined by a microcomputer, and a motor is set to a star connection by switches in the case of 36V, and to a delta connection in the case of 18V.

### TECHNICAL FIELD

The present invention relates to an electrical apparatus connectable to multiple types of battery packs.

### RELATED ART

An electrical apparatus has been disclosed to include a battery pack capable of changing an output voltage and an electrical apparatus main body to which the battery pack is connectable (Patent Document 1). The battery pack of Patent Document 1 includes two cell units and two sets of positive electrode terminals and negative electrode terminals respectively connected to the two cell units. The electrical apparatus main body includes a positive electrode input terminal connected to one positive electrode terminal, a negative electrode input terminal connected to another negative electrode terminal, and a connection element (short bar) connecting another positive electrode terminal and one negative electrode terminal. When the battery pack is connected to the electrical apparatus main body, the two cell units are connected in series via the connection element.

Patent Document 2 discloses an electrical apparatus in which an electrical apparatus main body has a predetermined rated voltage, and a battery pack different from the rated voltage and having a non-changeable output voltage is connectable to the electrical apparatus main body. In Patent Document 2, a set of positive electrode terminal and negative electrode terminal provided at the battery pack is configured to be connectable to a set of positive electrode input terminal and negative electrode input terminal provided at the electrical apparatus main body. Patent Document 3 discloses an electric power tool including a voltage switching part that switches a voltage supplied from a battery pack to the electric power tool according to the magnitude of a load applied to the electric power tool. Furthermore, Patent Document 4 discloses an electric power tool capable of alternatively connecting a battery pack capable of changing an output voltage between a high voltage and a low voltage and a battery pack capable of outputting only a high voltage. Furthermore, Patent Document 5 discloses changing a connection method of motor coils in accordance with an AC adapter or a DC adapter connected as a power source in an electrical apparatus main body.

### RELATED ART DOCUMENTS

### Patent Documents

Patent Document 1: WO 2018/230337
Patent Document 2: WO 2020/066905
Patent Document 3: JP 2012-66333 A
Patent Document 4: WO 2019/031272
Patent Document 5: JP 2019-047605 A

### SUMMARY OF INVENTION

### Problem to be Solved by Invention

The low/high voltage battery pack disclosed in Patent Document 1 is mountable to both a conventional 18V electrical apparatus main body and a 36V electrical apparatus main body, so the battery pack is very convenient in use. However, while the conventional 18V battery pack has a terminal part of an almost compatible shape, it cannot be physically mounted to the 36V electrical apparatus main body. If the existing 18V battery pack having a non-changeable output voltage can be configured to be also usable in a 36V electrical apparatus main body, the convenience of the new 36V electrical apparatus can be improved. In addition, if battery packs having various nominal voltages can be alternatively connected to the electrical apparatus main body, the electrical apparatus main body can be efficiently driven with high output according to the connected battery pack, and workability can be improved.

The present invention has been made in view of the above background, and it is an objective of the present invention to provide an electrical apparatus with improved convenience by extending compatibility between a battery pack and an electrical apparatus main body. Another objective of the present invention is to provide an electrical apparatus with improved workability.

### Means for Solving Problem

Representative features of the invention disclosed in this application are described as follows. According to a feature of the present invention, an electrical apparatus is alternatively connectable to a first battery pack capable of selectively outputting a high voltage or a low voltage and a second battery pack capable of outputting only the low voltage. The high voltage is supplied from the first battery pack to the electrical apparatus in a case where the first battery pack is connected to the electrical apparatus, and the low voltage is supplied from the second battery pack to the electrical apparatus in a case where the second battery pack is connected to the electrical apparatus. Further, the electrical apparatus includes a voltage switching part which switches a voltage supplied from a battery pack to the electrical apparatus. The voltage switching part switches the voltage supplied to the electrical apparatus from the first battery pack to the high voltage in a case where the first battery pack is connected to the electrical apparatus. Further, the voltage switching part is configured to maintain the voltage supplied to the electrical apparatus from the second battery pack at the low voltage in a case where the second battery pack is connected to the electrical apparatus.

According to another feature of the present invention, the voltage switching part of the electrical apparatus is configured such that a plurality of cells included in the first battery pack are connected to each other via the voltage switching part, and a plurality of cells included in the second battery pack are not connected to each other via the voltage switching part. Further, the voltage switching part includes a first switch part configured to be capable of connecting the plurality of cells included in the first battery pack to each other. The first switch part is turned on in a case where the first battery pack is connected to the electrical apparatus and is turned off in a case where the second battery pack is connected to the electrical apparatus. Furthermore, the electrical apparatus includes a motor having a plurality of coils. The electrical apparatus connects the plurality of coils to each other in a first connection configuration in a case where the first battery pack is connected to the electrical apparatus, and connects the plurality of coils to each other in a second connection configuration different from the first connection configuration in a case where the second battery pack is connected to the electrical apparatus. Accordingly, the first connection configuration is suitable for high voltage driving and the second connection configuration is suitable for low voltage driving. In a case where a same voltage is applied to the motor, comparing the first connection configuration and the second connection configuration, the second connection configuration allows a large current to flow more easily.

According to still another feature of the present invention, the first battery pack includes: a first cell unit and a second cell unit; a first positive electrode terminal connected to a positive electrode of the first cell unit; a first negative electrode terminal connected to a negative electrode of the first cell unit; a second positive electrode terminal connected to a positive electrode of the second cell unit; and a second negative electrode terminal connected to a negative electrode of the second cell unit. The second battery pack includes: a third cell unit included in at least one cell unit; a third positive electrode terminal connected to a positive electrode of the third cell unit; and a third negative electrode terminal connected to a negative electrode of the third cell unit. The electrical apparatus includes: a positive electrode input terminal connectable to the first positive electrode terminal and the third positive electrode terminal; a negative electrode input terminal connectable to the second negative electrode terminal and the third negative electrode terminal; a first connection terminal connectable to the first negative electrode terminal; a second connection terminal connectable to the second positive electrode terminal; a connection part connecting the first connection terminal and the second connection terminal to each other; and a load part connected to the positive electrode input terminal and the negative electrode input terminal. In a case where the first battery pack is connected to the electrical apparatus, the first positive electrode terminal is connected to the positive electrode input terminal, the second negative electrode terminal is connected to the negative electrode input terminal, the first negative electrode terminal is connected to the first connection terminal, the second positive electrode terminal is connected to the second connection terminal, and power is supplied from the first battery pack to the load part in a state in which the first cell unit and the second cell unit are connected in series to each other via the connection part. Further, in a case where the second battery pack is connected to the electrical apparatus, the third positive electrode terminal is connected to the positive electrode input terminal, the third negative electrode terminal is connected to the negative electrode input terminal, and power is supplied from the second battery pack to the load part. The electrical apparatus includes a control part connected to the first switch part. The control part is configured to switch on and off the first switch part depending on a battery pack connected.

According to still another feature of the present invention, the electrical apparatus includes a second switch part provided between the first negative electrode terminal and a ground line, and a third switch part provided between the second positive electrode terminal and a positive power line. The control part disconnects the second switch part and the third switch part in a case where the first battery pack is connected, and connects the second switch part and the third switch part in a case where the second battery pack is connected. An electrical apparatus is alternatively connectable to a first battery pack capable of selectively outputting a high voltage or a low voltage and a second battery pack capable of outputting only the low voltage. The electrical apparatus includes a motor having a plurality of coils. The plurality of coils are connected to each other in a first connection configuration in a case where the first battery pack is connected to the electrical apparatus, and the plurality of coils are connected to each other in a second connection configuration different from the first connection configuration in a case where the second battery pack is connected to the electrical apparatus. The first connection configuration is a star connection of the plurality of coils, and the second connection configuration is a delta connection of the plurality of coils.

### Effect of Invention

According to the present invention, an electrical apparatus with improved convenience can be provided. Further, an electrical apparatus with improved workability can be provided. Further, since a high-voltage electrical apparatus can be properly operated with a low-voltage battery pack, it is possible to provide an electrical apparatus with improved convenience and improved workability for an operator. Further, since the characteristic of the work load (motor) included in the high-voltage electrical apparatus is automatically switched to a star connection or a delta connection before operation according to the type of the mounted battery pack, work can be performed efficiently with high output according to the type of the battery pack.

### BRIEF DESCRIPTION OF DRAWINGS

FIG. 1 is an overall view of an electrical apparatus system according to an embodiment of the present invention.

FIG. 2 is a perspective view of an electrical apparatus 1 in FIG. 1.

FIG. 3 is a perspective view of a main body part of the electrical apparatus 1 in FIG. 1 viewed from another angle (lower side).

FIG. 4 is a view showing shapes of connection terminals of the electrical apparatus 1 and connection terminals of battery pack 200 and 250.

FIG. 5 is a circuit diagram when the low/high-voltage battery pack 200 is mounted to the electrical apparatus 1 of this embodiment.

FIG. 6 is a circuit diagram when the low-voltage battery pack 250 is mounted to the electrical apparatus 1 of this embodiment.

FIG. 7 is a flowchart showing a voltage switching procedure of the electrical apparatus 1 in this embodiment.

FIG. 8 is a circuit diagram when the low/high-voltage battery pack 200 is mounted to an electrical apparatus 1A according to a second embodiment of this embodiment.

FIG. 9 is a circuit diagram when the low-voltage battery pack 250 is mounted to the electrical apparatus 1A according to the second embodiment of this embodiment.

FIG. 10 is a circuit diagram when a low/high-voltage battery pack 200A is mounted to an electrical apparatus 1B according to a third embodiment of this embodiment.

(A) of FIG. 11 is a top view of a battery pack mounting part 10B of the electrical apparatus 1B shown in FIG. 10, and (B) of FIG. 11 is a top view of the low/high voltage battery pack 200A.

FIG. 12 is a circuit diagram when the low-voltage battery pack 250 is mounted to the electrical apparatus 1B according to the third embodiment of this embodiment.

FIG. 13 is a view showing a switching example of control characteristics of the motor, (A) of FIG. 13 is a view showing a relationship between the motor rotational speed and the motor torque in the case where an electrical advance angle is changed, and (B) of FIG. 13 is a view showing a relationship between the motor rotational speed and the motor torque in the case where a conduction angle is changed.

### DESCRIPTION OF EMBODIMENTS

### Embodiment 1

Embodiments of the present invention will be described below with reference to the drawings. In the drawings below, the same parts will be labeled with the same reference signs, and repeated descriptions will be omitted. Further, in this specification, the front, rear, left, right, up, and down directions will be described as the directions shown in the drawings.

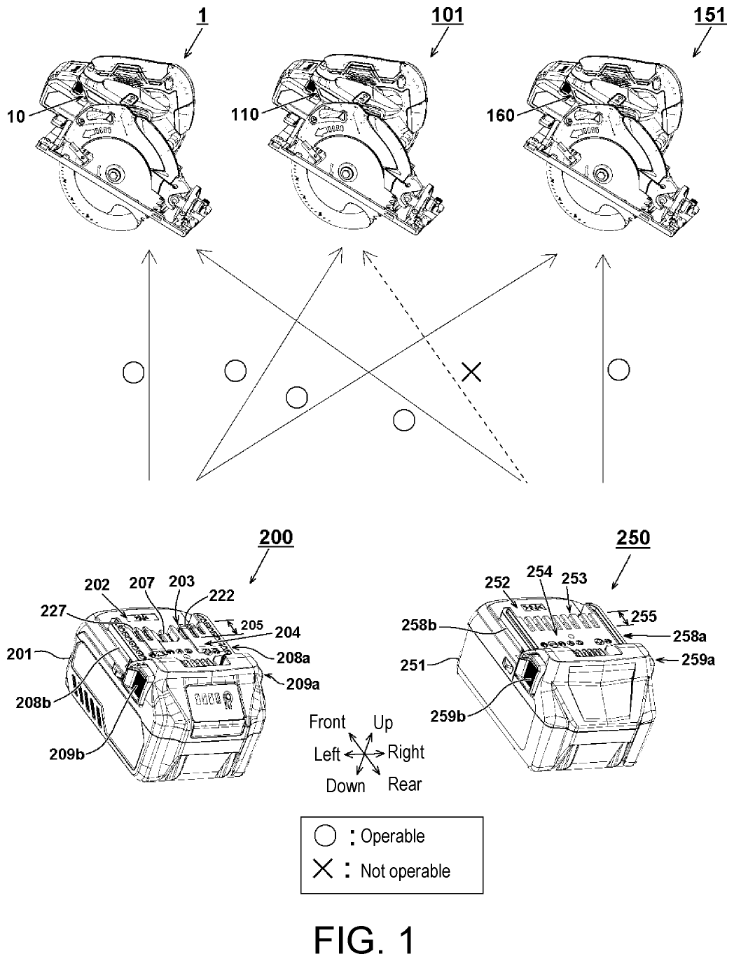

FIG. 1 is an overall view of an electrical apparatus system according to an embodiment of the present invention. The electrical apparatus system is composed of a plurality of electrical apparatus main bodies (1, 101, 151) and a plurality of battery packs (200, 250). The electrical apparatus main bodies (1, 101, 151) are apparatuses that operate by mounting any of the compatible battery packs (200, 250) and are cordless apparatuses that do not require AC power. The electrical apparatus main bodies (1, 101, 151) are classified according to the rated voltage of the battery pack used, and herein, in addition to a conventional electrical apparatus 101 configured to receive a high-voltage supply of a rated voltage 36V and a conventional electrical apparatus 151 configured to receive a low-voltage supply of a rated voltage 18V, the electrical apparatus main bodies (1, 101, 151) also include an electrical apparatus 1 according to this embodiment capable of operating at both the rated voltage 36V and the rated voltage 18V. In this specification, the state in which the battery pack (200, 250) is mounted will be referred to as an “electrical apparatus”, and the main body side in the state in which the battery pack (200, 250) is removed will be referred to as an “electrical apparatus main body”.

In the electrical apparatus 1 having a brushless motor, to realize the electrical apparatus 1 that operates at both voltages of 18V and 36V, a battery pack 200 capable of outputting a low voltage and a high voltage (18V and 36V) and a conventional battery pack 250 for 18V are configured to be both insertable (mountable) into a battery pack mounting part 10. Further, the battery pack 200 is configured to be capable of outputting an identification signal indicating the type of the battery pack itself, such that a control part of the electrical apparatus 1 can identify whether the mounted battery pack is a battery pack 1 compatible with dual voltages or otherwise a low-voltage battery pack.

The conventional electrical apparatus 151 is an apparatus that operates at the rated voltage 18V and operates by mounting the battery pack 250 for the rated voltage 18V. The conventional electrical apparatus 101 is an apparatus that operates at the rated voltage 36V and operates with a battery pack capable of outputting the rated voltage 36V (in the product sold by the applicant, a battery pack 200 capable of switching between 18V and 36V output).

Although FIG. 1 shows an example of a circular saw that operates with either of the battery packs 200 and 250 as the electrical apparatuses 1, 101, and 151, the type of the electrical apparatus main body is arbitrary and not limited to a circular saw but includes a variety of apparatuses such as an impact driver, an impact wrench, a driver drill, a disc grinder, a hammer drill, a blower, a cleaner, a cutter, a bandsaw, a multi-tool, a jigsaw, a saber saw, a chainsaw, a hand plane, a pin nailer, a tacker, a nailer, a television, a radio, a speaker, a fan, a cold-hot storage, a light, a high-pressure washer, a trimmer, etc.

The battery pack 200 capable of outputting a low voltage (18V output) or a high voltage (36V output) is operable by mounting to the conventional electrical apparatuses 101 and 151 as indicated by solid arrows and circle marks, and is also operable by mounting to the electrical apparatus 1 according to this embodiment. On the other hand, the low-voltage (18V) battery pack 250 is operable by mounting to the conventional electrical apparatus 151, but is not mountable (i.e., not operable) to the high-voltage electrical apparatus 101 as indicated by a cross mark. However, the electrical apparatus 1 according to this embodiment is formed with a battery pack mounting part 10 allowing mounting of the battery pack 250 and is configured to be also operable at the low voltage of 18V.

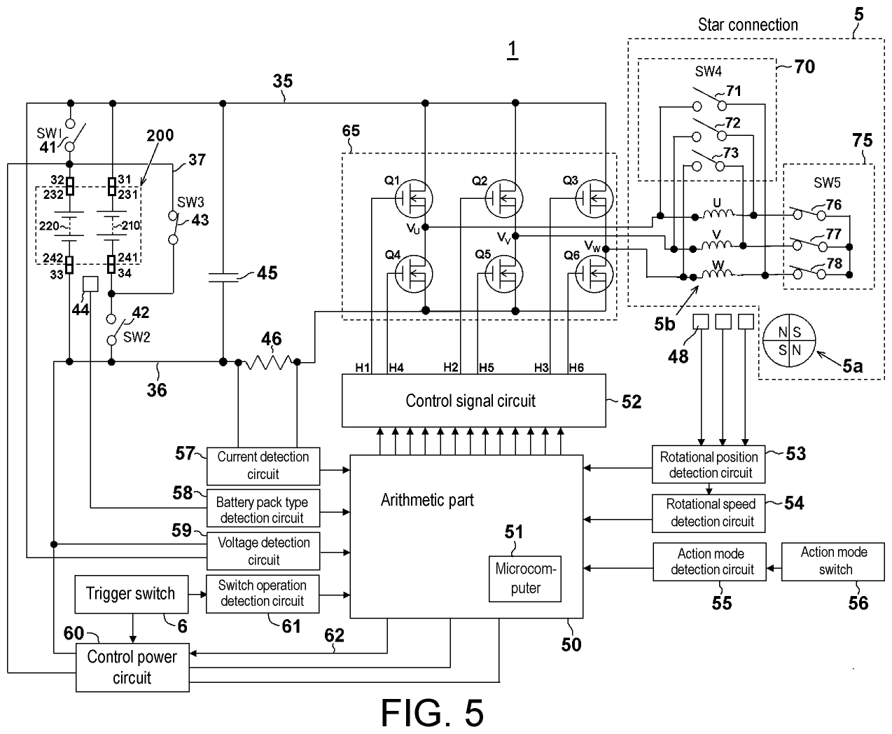

The electrical apparatus 1 basically operates at 36V, but is configured to also operate with an 18V power source when the low-voltage (18V) battery pack 250 is mounted. To enable this dual-voltage operation, the connection state of the built-in motor is changed, or the rotation control method of the motor is changed (these changes will be described later with reference to FIG. 5 and subsequent figures).

The battery pack 200 accommodates a plurality (herein, 10) of battery cells in a case 201 made of synthetic resin. From the front side to the rear side on the upper surface of the battery pack 200, a lower-step surface 202 and an upper-step surface 204 are formed, and a step part 203 is formed between the lower-step surface 202 and the upper-step surface 204. A slot group 205 is formed with eight slot-shaped notches from the step part 203 to a front portion of the upper-step surface 204. Connection terminals of a terminal part of the electrical apparatus 1, 101, and 151 are inserted into the slots of the slot group 205. Rail grooves 208a and 208b are formed on an upper lateral surface of the battery pack 200 for mounting to the battery pack mounting parts 10, 110, and 160 of the electrical apparatuses 1, 101, and 151, and latch buttons 209a and 209b constituting a latch mechanism are arranged on the rear side of the rail grooves 208a and 208b for maintaining or releasing the mounting state with the main body part of the electrical apparatuses 1, 101, and 151. In the slot group 205, a portion of the fifth and sixth slot parts counted from the right is formed in a shape recessed downward from the upper-step surface. This recessed portion serves as a stopper part 207 for preventing incorrect battery mounting.

The battery pack 250 accommodates a plurality (herein, 10) of battery cells in a case 251 made of synthetic resin. The battery pack 200 is designed by rendering compatibility to an upper shape based on the battery pack 250 for 18V, so the external shape of the upper half of the battery pack 250 is the same (compatible) as the battery pack 200 except that the stopper part 207 is not provided. From the front side to the rear side on the upper surface of the battery pack 250, a lower-step surface 252 and an upper-step surface 254 are formed, and a step part 253 is formed therebetween. In addition, a slot group 255 is formed with eight slot-shaped notches from the step part 253 to a front portion of the upper-step surface 254. Rail grooves 258a and 258b and latch buttons 259a and 259b are formed on left and right sides sandwiching the slot group 255.

As indicated by the solid lines in FIG. 1, the battery pack 200 is mountable to the electrical apparatuses 1, 101, and 151, and is capable of supplying a DC power of 36V or 18V to the electrical apparatuses 1, 101, and 151. On the other hand, the battery pack 250 is mountable not only to the compatible electrical apparatus 151 but also to the electrical apparatus 1 according to this embodiment, and is capable of supplying a DC power of 18V to the electrical apparatuses 1 and 151. However, the battery pack 250 is not capable of mounting to the battery pack mounting part 110 of the electrical apparatus 101 for 36V.

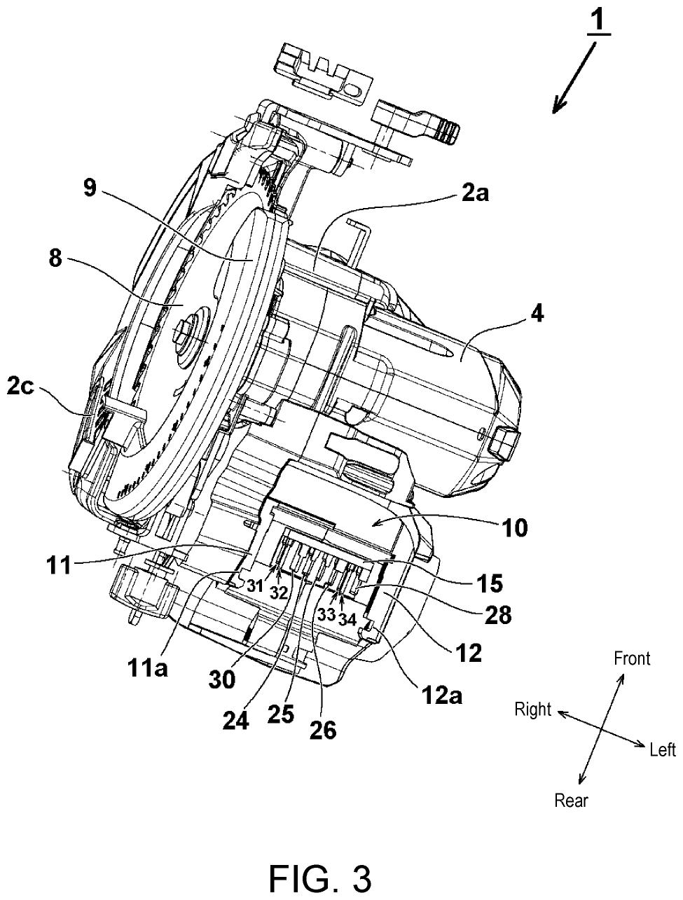

In the electrical apparatus 101 which operates at a single voltage of 36V, a stopper piece (not shown) that forms a protrusion compatible with the stopper part 207 of the battery pack 200 is formed at the battery pack mounting part 110. The stopper piece has a shape that extends downward from an upper wall in the vicinity of the connection terminal, and when the battery pack 200 is mounted, the stopper piece is positioned in the stopper part 207 such that the battery pack 200 and the terminal part are fitted together. Accordingly, in the electrical apparatus 101, since the stopper piece is conventionally formed at the terminal part, if the battery pack 250, which does not have a recess (stopper part 207) compatible with the stopper piece, is mounted to the electrical apparatus 101, the stopper piece in a protruding shape formed at the terminal part of the electrical apparatus 101 interferes with the step part 253, so the battery pack 250 is physically not capable of mounting to the electrical apparatus 101. On the other hand, in the electrical apparatus 1 according to this embodiment, the stopper piece in a protruding shape, which is conventionally provided in a 36V electrical apparatus, is omitted from the terminal part (details will be described later with reference to FIG. 3), and the battery pack 250 is mountable to the battery pack mounting part 10 of the electrical apparatus 1.

The electrical apparatus 1 is an electrical apparatus for 36V which basically operates at the voltage of 36V. Herein, by mounting the battery pack 200 compatible with multiple voltages of 18V/36V, a direct current of 36V is supplied from the battery pack 200. On the other hand, in the case where the battery pack 250 is mounted to the battery pack mounting part 10 of the electrical apparatus 1, since the supply voltage is 18V, the electrical apparatus 1 operates at the low voltage of 18V.

The electrical apparatus 101 operates at the voltage of 36V. Herein, by mounting the battery pack 200 compatible with multiple voltages of 18V/36V, a direct current of 36V is supplied from the battery pack 200. The electrical apparatus 151 operates with an 18V battery pack. Herein, by mounting the battery pack 200 compatible with multiple voltages of 18V/36V, a direct current of 18V is supplied from the battery pack 200. Also, by mounting the battery pack 250 compatible with a single voltage of 18V, a direct current of 18V is supplied from the battery pack 250.

Although not shown in FIG. 1, the battery packs 200 and 250 are chargeable using an external charger for 18V (not shown) after being removed from the electrical apparatus main body (1, 101, 151). In the electrical apparatus system shown in FIG. 1, the combination of low voltage and high voltage is composed of 18V and 36V. However, regarding the low voltage and the high voltage shown in this specification, of any two rated voltages, the high-voltage side will be referred to as “high voltage” and the low-voltage side will be referred to as “low voltage”. Thus, the combination of low voltage/high voltage may include not only 18V/36V but also other combinations of voltages.

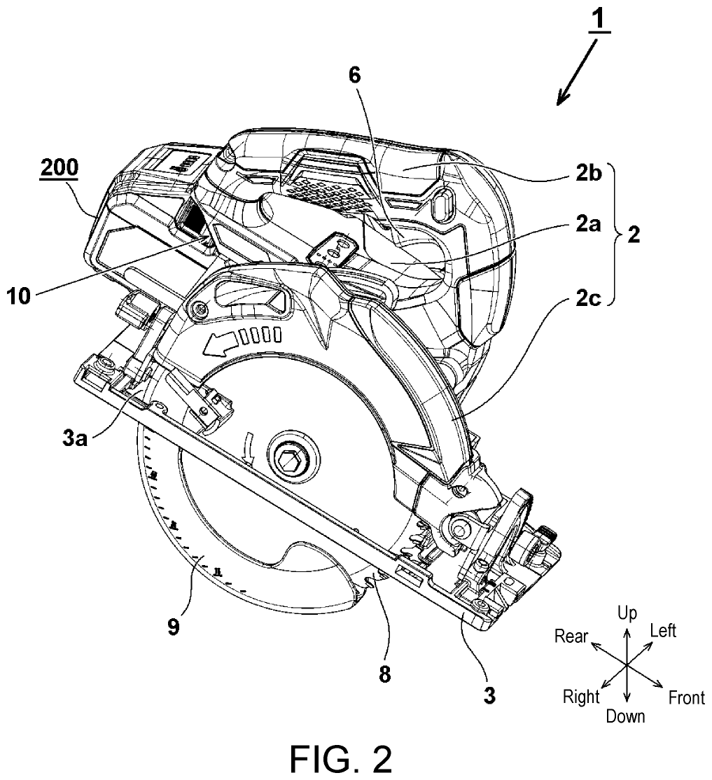

FIG. 2 is a perspective view of the electrical apparatus 1 in FIG. 1. As an illustrated example, the electrical apparatus 1 is an electric circular saw that basically operates at 36V but is also operable at 18V. The electrical apparatus 1 includes a housing 2 that supports a saw blade 8 rotatably and a base 3. The housing 2 includes a main body part 2a, a handle part 2b, and a saw cover 2c, and accommodates therein a motor 5 (not visible in the figure) as a load part and a control board. The housing 2 is manufactured, for example, by integral molding of synthetic resin. The battery pack mounting part 10 is formed on the rear side of the housing 2 below the handle part 2b, and the battery pack 200 of dual voltages capable of outputting low/high voltages is mounted thereto. The saw blade 8 is attached to a rotation shaft of the motor (not shown). The saw blade 8 has a circular plate shape and rotates on the right side of the main body part 2a. The base 3 is a plate-shaped member made of metal such as aluminum or the like, and has a cutout part 3a that penetrates in the up-down direction and extends in the front-rear direction, and a large lower-side portion of the saw blade 8 protrudes downward from the base 3 through the cutout part 3a. A protective cover 9 movable in the circumferential direction is provided on the outer peripheral side of the saw blade 8 on the lower side of the base 3.

In the case of cutting a workpiece such as a wooden board by attaching the battery pack 200 to the battery pack mounting part 10 of the electrical apparatus 1, an operator grips the handle part 2b with one hand, presses the base 3 against the upper surface of the workpiece, and rotates the motor (not shown) by pulling a trigger switch 6. With the saw blade 8 rotating, the operator moves the lower surface of the base 3 forward while sliding the lower surface of the base 3 over the upper surface of the workpiece. When a portion of the saw blade 8 below the lower surface of the base 3 presses against the workpiece, the protective cover 9 moves relatively to a side opposite to the rotational direction to cut the workpiece by the saw blade 8.

FIG. 3 is a perspective view of the main body part of the electrical apparatus 1 viewed from another angle (lower side), showing the shape of the battery pack mounting part 10. Herein, for clarity, illustration of the base 3 is omitted. A motor cover 4 covering the motor 5 arranged coaxial with the rotation shaft of the saw blade 8 is provided on the left side of the main body part 2a. The battery pack mounting part 10 is formed on the rear side of the motor cover 4. The battery pack mounting part 10 is formed with two parallel rail parts 11 and 12, and a terminal part 15 is arranged at an inner portion of the rail parts 11 and 12. Since a protrusion (not shown) that inhibits mounting of the battery pack 250 for 18V is not formed at the terminal part 15, mounting of the battery pack 250 for 18V is also possible.

The rail parts 11 and 12 are portions formed in a rail shape by protruding from sidewall portions on left and right sides of a space accommodating the terminal part 15 into protruding shapes toward the inner side (left-right center line of the terminal part 15), and extending the protruding portions continuously from the rear side to the front side. The rail parts 11 and 12 are formed plane-symmetrically with respect to a vertical plane passing through the left-right center line of the terminal part 15, and longitudinal directions of the rail parts 11 and 12 are parallel directions. When mounting the battery pack 200 to the terminal part 15, the rail part 11 guides the rail groove 208a of the battery pack 200, and the rail part 12 guides the rail groove 208b of the battery pack 200, such that the battery pack 200 is mounted to the battery pack mounting part 10. In this state, latch claws (not shown; protrusions movable to protrude outward from groove bottom parts of the rail grooves 208a and 208b) of the battery pack 200 engage with latch grooves (recesses 11a and 11b) formed on the front end side of the rail parts 11 and 12 by an urging force (not shown) of a latch mechanism, to fix the battery pack 200 so as not to be removed from the terminal part 15.

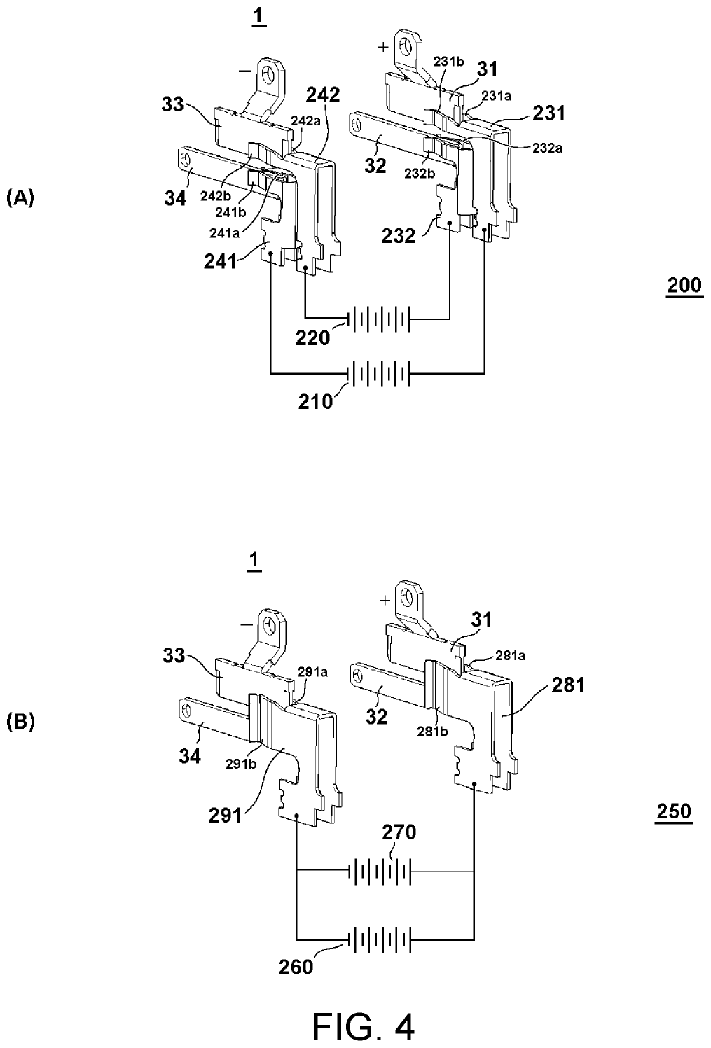

Four power terminals (31 to 34), four signal terminals (24 to 26, 28), and one partition plate 30 are formed at the terminal part 15. The four power terminals (31 to 34) and the four signal terminals (24 to 26, 28) are firmly fixed by being cast into a base portion made of synthetic resin of the terminal part 15. A positive electrode input terminal 31 and a second connection terminal 32 are aligned in the up-down direction and arranged to be inserted into the same slot (slot 222 in FIG. 1). A negative electrode input terminal 33 and a first connection terminal 34 are aligned in the up-down direction and arranged to be inserted into the same slot (slot 227 in FIG. 1). Next, the shapes of the four power terminals (31 to 34) and the shapes of the connection terminals on the compatible battery pack 200 and 250 side will be described with reference to FIG. 4.

(A) of FIG. 4 is a partial perspective view showing the shapes of the positive electrode terminals (231 and 232) and the negative electrode terminals (241 and 242) of the battery pack 200 according to this embodiment, and the connection terminals (31 to 34) of the electrical apparatus 1. A first positive electrode terminal 231 with an arm located on an upper side and a second positive electrode terminal 232 with an arm located on a lower side are provided as the positive electrode terminals (positive electrode output terminals) of the battery pack 200. The first positive electrode terminal 231 and the second positive electrode terminal 232 are located in the same slot (slot 222, which is the second slot counted from the right in the slot group 205 in FIG. 1) and are fixed to a circuit board (not shown) such that their respective legs are aligned in the front-rear direction. Similarly, a second negative electrode terminal 242 with an arm located on an upper side and a first negative electrode terminal 241 with an arm located on a lower side are provided. The first negative electrode terminal 241 and the second negative electrode terminal 242 are located in the same slot (slot 227, which is the second slot counted from the left in the slot group 205 in FIG. 1) and are fixed to the circuit board (not shown) such that their respective legs are aligned in the front-rear direction.

The first positive electrode terminal 231 and the second positive electrode terminal 232 each have an arm set (arms 231a and 231b, arms 232a and 232b) extending toward the front side. Herein, the first positive electrode terminal 231 and the second positive electrode terminal 232 are formed in shapes such that the arms 231a and 231b and the arms 232a and 232b are located at positions separated in the up-down direction, and front-rear direction positions of fitting parts thereof are substantially the same. The positive electrode terminal pair composed of the positive electrode terminals 231 and 232 is arranged in a space accessible from one slot 222 (see FIG. 1) of the battery pack 200. The negative electrode terminal pair has the same shape as the positive electrode terminal pair and is composed of the second negative electrode terminal 242 and the first negative electrode terminal 241. The negative electrode terminal pair (242 and 241) is arranged in a space accessible from one slot 226 (see FIG. 1) of the battery pack 200. Although not shown in FIG. 4, a positive electrode terminal pair (not shown) for charging is arranged on the right side of the positive electrode terminal pair (first positive electrode terminal 231 and second positive electrode terminal 232) for discharging. The shape of the positive electrode terminal pair for charging is the same as that of the first positive electrode terminal 231 and the second positive electrode terminal 232. The first positive electrode terminal 231 and the second negative electrode terminal 242 use a common metal component formed by press working of a metal plate. Similarly, the second positive electrode terminal 232 and the first negative electrode terminal 241 use a common metal component formed by press working of a metal plate.

A cell unit (210, 220) in which five lithium-ion battery cells are connected in series is accommodated inside the battery pack 200. Since the rated voltage of the lithium-ion battery cell is 3.6V/cell, the total of the first cell unit 210 is 18V (nominal value), and the total of the second cell unit 220 is 18V (nominal value). The positive electrode of the first cell unit 210 is connected to the first positive electrode terminal 231, and the negative electrode is connected to the first negative electrode terminal 241. Similarly, the positive electrode of the second cell unit 220 is connected to the second positive electrode terminal 232, and the negative electrode is connected to the second negative electrode terminal 242.

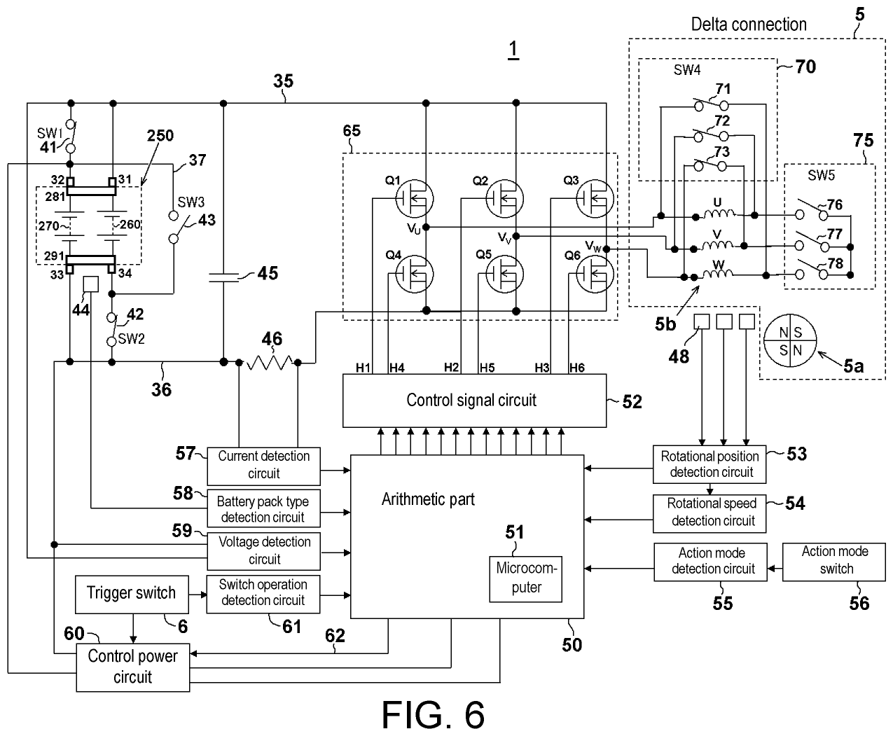

Connection terminals on the electrical apparatus side connected to the battery pack 200 are prepared, including a positive electrode input terminal 31, a negative electrode input terminal 33, a first connection terminal 34, and a second connection terminal 32. These connection terminals (31 to 34) are fixed by being cast into the base part made of the synthetic resin of the terminal part 15 and are connected to a power line 35, a ground line 36, and a short-circuit line 37 (all to be described later with reference to FIG. 5 and FIG. 6) by soldering at connection parts formed with through-holes. The first connection terminal 34 and the second connection terminal 32 are used to form a series connection state of the first cell unit 210 and the second cell unit 220 by short-circuiting using a third switch 43 (see FIG. 5) to be described later.

(B) of FIG. 4 is a partial perspective view showing the shapes of a positive electrode terminal 281 and a negative electrode terminal 291 of the battery pack 250 according to this embodiment, and the connection terminals (31 to 34) of the electrical apparatus 1. The connection terminals (31 to 34) of the electrical apparatus 1 have the same shape as in (A) of FIG. 4. The battery pack 250 is a battery pack for 18V and accommodates therein two cell units (260, 270). In the case where the battery pack 250 is 18V, it is possible to include only one cell unit, i.e., only five lithium-ion battery cells. However, herein, a third cell unit 260 composed of five lithium-ion battery cells connected in series and a fourth cell unit 270 are connected in parallel, their positive electrode side outputs are connected to the third positive electrode terminal 281, and their negative electrode side outputs are connected to the third negative electrode terminal 291 to increase the capacity.

Arms 281a and 281b of the third positive electrode terminal 281 have a large width in the up-down direction, and are formed into a shape connecting the arms 231a and 231b of the first positive electrode terminal 231 and the arms 232a and 232b of the second positive electrode terminal 232 of the battery pack 200 respectively in the up-down direction without a gap. Similarly, the arms 291a and 291b of the third negative electrode terminal 291 also have a large width in the up-down direction, and are formed into a shape connecting the arms 242a and 242b of the second negative electrode terminal 242 and the arms 241a and 242b of the first negative electrode terminal 241 of the battery pack 200 respectively in the up-down direction without a gap. With such terminal shapes of the third positive electrode terminal 281 and the third negative electrode terminal 291, in the fitted state shown in (B) of FIG. 4 (with the battery pack 250 mounted to the electrical apparatus 1), the positive electrode input terminal 31 and the second connection terminal 32 of the electrical apparatus 1 are short-circuited by being simultaneously connected to the third positive electrode terminal 281. Similarly, the negative electrode input terminal 33 and the first connection terminal 34 of the electrical apparatus 1 are short-circuited by being simultaneously connected to the third negative electrode terminal 291.

FIG. 5 is a circuit diagram when the battery pack 200 is mounted to the electrical apparatus 1 of this embodiment. The electrical apparatus 1 of this embodiment includes an arithmetic part (control part) 50 including a microcomputer 51. Although not shown, the microcomputer 51 is built-in with a CPU for outputting drive signals based on a processing program and data, a ROM for storing a program corresponding to a flowchart to be described later and control data, a RAM for temporarily storing data, a timer, etc., and the microcomputer 51 performs rotation control on the motor 5 and voltage and current monitoring on the mounted battery pack 200 or 250. In the embodiment of FIG. 5, the battery pack 200 which is rechargeable and capable of outputting low voltage or high voltage is used as the power source. The battery pack 200 is mounted to the battery pack mounting part 10 (see FIG. 3) of the electrical apparatus 1. As shown in FIG. 3, the positive electrode input terminal 31 and the second connection terminal 32 are provided on the positive electrode side of the battery pack mounting part 10, and the negative electrode input terminal 33 and the first connection terminal 34 are provided on the negative electrode side. The output of the positive electrode input terminal 31 is transmitted to an inverter circuit 65 via the power line (positive power line) 35, and the output of the negative electrode input terminal 33 is transmitted to the inverter circuit 65 via the power line (ground line) 36. A shunt resistor 46 is interposed in the path of the power line 36. In addition, a capacitor 45 is provided between the power line 35 and the power line 36. The capacitor 45 is provided for smoothing and noise countermeasures.

The battery pack 200 accommodates two sets of cell units (210, 220) as shown in FIG. 4, and the output of the first cell unit 210 is wired to the first positive electrode terminal 231 and the first negative electrode terminal 241, and the output of the second cell unit 220 is wired to the second positive electrode terminal 232 and the second negative electrode terminal 242. By mounting the battery pack 200 to the battery pack mounting part 10 of the electrical apparatus 1, the first positive electrode terminal 231 is fitted to the positive electrode input terminal 31, and the second positive electrode terminal 232 is fitted to the second connection terminal 32. A first switch 41 is interposed in the path between the second connection terminal 32 and the power line 35. A second switch 42 is interposed in the path between the first connection terminal 34 and the power line 36. Furthermore, a short-circuit line 37 is provided to connect the second connection terminal 32 and the first connection terminal 34, and a third switch 43 is provided for connecting or disconnecting this path.

The four power terminals (31 to 34) and the first to third switches 41 to 43 constitute a voltage switching part that switches the voltage from the battery pack 200. The first to third switches 41 to 43 are formed using conventional mechanical relays, MOS FET relays, or semiconductor switching elements such as FETs, and their opening and closing are independently controllable by control signals (wiring thereof not shown in the figure) from the microcomputer 51 of the arithmetic part 50. In the case of using mechanical relays as the first to third switches 41 to 43, it is preferable to use double-pole single-throw relay switches with an a-contact configuration. A detector 44 for detecting the type of the mounted battery pack is provided in the vicinity of the battery pack 200. The detector 44 may perform determination by some mechanical mechanisms, or may identify whether the mounted battery pack is a low/high-voltage switching type battery pack 200 or a single-voltage (low-voltage) battery pack 250 by using electrical signals or optical recognition techniques. One of the methods for easily performing this identification is to detect a signal level of the signal terminal provided at the battery packs 200 and 250. For example, the detector 44 transmits a signal of a T terminal for battery identification signal output of the battery pack 200 to a battery pack type detection circuit 58. With the battery pack type detection circuit 58 reading the signal from the T terminal of the battery pack 200 or 250 immediately after the battery pack 200 or 250 is mounted, the microcomputer 51 can identify which of the battery packs 200 and 250 has been mounted.

The output of the battery pack 200 is transmitted to the inverter circuit 65 via the power lines 35 and 36. The inverter circuit 65 is composed of a plurality (herein, six) of semiconductor switching elements Q1 to Q6, and the switching operation is controlled according to gate signals H1 to H6 supplied from a control signal circuit 52 under control of the arithmetic part 50. The switching elements Q1 to Q6 are field-effect transistors (FET) herein, but may also be insulated gate bipolar transistors (IGBT). The output of the inverter circuit 65 is connected to one end side of the U-phase, V-phase, and W-phase of the coils of the motor 5.

A control power circuit 60 is a power circuit that supplies a direct current of a stable reference voltage Vcc (e.g., 5V or 3.3V) for operation of the arithmetic part 50. The control power circuit 60 is connected to the second connection terminal 32 and the negative electrode input terminal 33, and further also receives a status signal of a trigger switch 6. Upon mounting of the battery pack 200 (or 250), the battery voltage (direct current of 18V) is supplied to the control power circuit 60. With this battery voltage being applied, when a lever of the trigger switch 6 is pulled to turn on, the control power circuit 60 starts the power supply to the arithmetic part 50. By using the status signal of the trigger switch 6 to start the control power circuit 60 in this manner, since the microcomputer 51 of the arithmetic part 50 does not start simply by mounting of the battery pack 200 (or 250), power consumption in the non-use state of the electrical apparatus can be suppressed. Further, upon turn-on of the trigger switch 6, since the power supply from the control power circuit 60 to the arithmetic part 50 starts, the arithmetic part 50 including the microcomputer 51 starts, and it becomes possible to control “on” or “off” of the first to fifth switches (41 to 43, 70, 75). Even if the trigger switch 6 is turned off, the power supply to the arithmetic part 50 is maintained for a certain period of time (e.g., 5 minutes) due to a start maintenance signal 62 from the arithmetic part 50.

With the microcomputer 51 controlling the control signal circuit 52, “on” or “off” of the gate signals H1 to H6 to the semiconductor switching elements Q1 to Q6 of the inverter circuit 65 is switched. The motor 5 is a conventional brushless motor of the so-called inner rotor type, and is composed of a rotor 5a in which a magnet (permanent magnet) including a pair of N poles and S poles is embedded, and a stator 5b arranged on the outer peripheral side of the rotor 5a. The stator 5b has six teeth (not shown) from a cylindrical part on the outer peripheral side toward the inner side, and an insulator (not shown) made of synthetic resin is provided on two sides of the rotation axis direction of the six teeth.

To guide strong magnetic lines of force, a stator core (not shown) is composed of a laminated structure of steel plates, for example. Six coil elements are formed by winding an enameled wire multiple times respectively on the outer peripheral side of two insulators and the teeth sandwiched by the insulators. Three coils of U-phase, V-phase, and W-phase are formed by connecting each two of the six coil elements in series. One end side of the three coils of U-phase, V-phase, and W-phase is connected to the inverter circuit 65 (V_{V}, V_{U}, and V_{W} in the figure), and another end side is connected to the fifth switch 75.

The fifth switch 75 is a switching switch group for short-circuiting or opening the another end side of the three coils of U-phase, V-phase, and W-phase and includes three switches 76 to 78. The fifth switch 75 is composed of conventional mechanical relays, MOS FET relays, or semiconductor switching elements such as FETs, and switching of the connection state is performed according to a control signal (wiring thereof not shown in the figure) from the microcomputer 51. In the case of using mechanical relays, it is preferable to use double-pole single-throw relay switches with an a-contact configuration. The three switches 76 to 78 are linked and switched on or off collectively, and in the connection state of FIG. 5 (the switches 76 to 78 are on, and the switches 71 to 73 are off), the ends of U-phase, V-phase, and W-phase are connected to form a “star connection” formed with a midpoint.

The fourth switch 70 is a switching switch group for forming a “delta connection” by the three coils of U-phase, V-phase, and W-phase and includes three switches 71 to 73. The switch 71 is arranged in a wiring that short-circuits an inverter circuit 65-side end of U-phase and a midpoint-side end of W-phase. Similarly, the switch 72 is arranged in a wiring that short-circuits an inverter circuit 65-side end of V-phase and a midpoint-side end of U-phase, and the switch 73 is arranged in a wiring that short-circuits an inverter circuit 65-side end of W-phase and a midpoint-side end of V-phase. The fourth switch 70 is composed of conventional mechanical relays, MOS FET relays, or semiconductor switching elements such as FETs, and switching of the connection state is performed according to a control signal (wiring thereof not shown in the figure) from the microcomputer 51. In the case of using mechanical relays, it is preferable to use double-pole single-throw relay switches with an a-contact or b-contact configuration. The three switches 71 to 73 are linked and switched on or off collectively, and in the connection state of FIG. 6 to be described later (the three switches 71 to 73 are on, and the switches 76 to 78 are off), a “delta connection” is formed.

Three position detection elements 48 are provided in the vicinity of the rotor 5a of the motor 5. The position detection element 48 is arranged on the inverter circuit 65 at intervals of a rotational angle 60°. A rotational position detection circuit 53 is a circuit that detects the relative position between the rotor 5a and armature windings U, V, and W of the stator 5b based on the output signals of the three position detection elements 48. A rotational speed detection circuit 54 is a circuit that detects the rotational speed of the motor 5 based on a quantity of detection signals from the rotational position detection circuit 53 counted per unit time.

The fourth and fifth switches 70 and 75 are provided only at the electrical apparatus 1 compatible with 18V/36V and are not provided at the electrical apparatus 101 for 36V and the electrical apparatus 151 for 18V shown in FIG. 1. In the electrical apparatus 101 and the electrical apparatus 151, three coils of U-phase, V-phase, and W-phase are directly soldered or are connected to an inverter circuit board (not shown) provided at the motor 5 to set a “delta connection” or a “star connection”. In other words, it is not possible to switch between a “delta connection” and a “star connection” in the electrical apparatus 101 and the electrical apparatus 151.

As described above, since the fourth switch 70 and the fifth switch 75 are provided at the electrical apparatus 1 which operates at dual voltages, when the low/high-voltage battery pack 200 is mounted, before operation of the motor 5, by turning the switches 71 to 73 of the fourth switch 70 all off and turning the switches 76 to 78 of the fifth switch 75 all on, a star connection state can be set. Similarly, as shown in FIG. 6 to be described later, when the 18V battery pack 250 is mounted, before operation of the motor 5, by turning the switches 71 to 73 of the fourth switch 70 all on and turning the switches 76 to 78 of the fifth switch 75 all off, a delta connection state (state of FIG. 6 to be described later) can be set.

By measuring two-end voltages of the shunt resistor 46, a current detection circuit 57 measures the current flowing through the motor 5 and outputs to the arithmetic part 50. A voltage detection circuit 59 is a circuit that detects the voltage between the second connection terminal 32 and the negative electrode input terminal 33 and outputs to the arithmetic part 50. A switch operation detection circuit 61 detects whether the lever of the trigger switch 6 is pulled and outputs a signal corresponding to a pull amount of the lever to the arithmetic part 50. The microcomputer 51 of the arithmetic part 50 sets an applied voltage of the motor 5, i.e., a duty ratio of a PWM signal, in response to a movement stroke amount of the lever of the trigger switch 6. An action mode switch 56 is a switch for setting the rotational speed of the motor 5 stepwise, and an action mode detection circuit 55 detects a setting status of the switch and outputs to the arithmetic part 50.

In the electrical apparatus 1 described above, upon mounting of the battery pack 200 to the battery pack mounting part 10, since an 18V output from the second cell unit 220 is supplied to the control power circuit 60, at a timing when the trigger switch 6 is first turned on, the control power circuit 60 generates and supplies the reference voltage Vcc to the arithmetic part 50. Since the microcomputer 51 starts upon supply of the reference voltage Vcc to the control power circuit 60, the microcomputer 51 determines whether the mounted battery pack is the 18V/36V battery pack 200 or the 18V battery pack 250, sets “on” and “off” of the first to third switches 41 to 43 accordingly, and then sets “on” and “off” of the fourth and fifth switches 70 and 75. In the circuit diagram of FIG. 5, the 18V/36V battery pack 200 is mounted, the first switch 41 and the second switch 42 are turned off, and the third switch 43 is turned on. In this connection state, a rated direct current 36V is supplied between the power line 35 and the ground line 36. On the other hand, to form a star connection in the motor 5, each of the switches 71 to 73 of the fourth switch 70 is turned off, and each of the switches 76 to 78 of the fifth switch 75 is brought into a connected state (on).

FIG. 6 is a circuit diagram when the low-voltage battery pack 250 is mounted to the battery pack mounting part 10 of the electrical apparatus 1 of this embodiment. The circuit of the electrical apparatus 1 is exactly the same as that of FIG. 5, and only the connection states of the first to third switches 43 and the connection states of the fourth and fifth switches 70 and 75 are different. The mounted battery pack 250 has a rated 18V and has terminal shapes such as the third positive electrode terminal 281 and the third negative electrode terminal 291 in (B) of FIG. 4. Upon mounting of the low-voltage battery pack 250 to the battery pack mounting part 10 of the electrical apparatus 1, a direct current of rated 18V is outputted from the battery pack 250 to the positive electrode input terminal 31 and the negative electrode input terminal 33. At this time, the microcomputer 51 maintains the first switch 41 and the second switch 42 in the on-state and brings the third switch 43 into the off-state. Next, the microcomputer 51 switches the fourth switch 70 and the fifth switch 75 to set the connection state of the motor 5 to a delta connection. That is, the microcomputer 51 maintains each of the switches 71 to 73 of the fourth switch 70 in the on-state and maintains each of the switches 76 to 78 of the fifth switch 75 in the off-state.

In the case where the motor 5, which is normally star-connected and driven at 36V, is driven at 18V, it is advantageous to switch to a delta connection instead of a star connection. This is because the delta connection can easily increase a large current even at a low voltage and can increase the rotational speed of the motor 5 at the same generated torque.

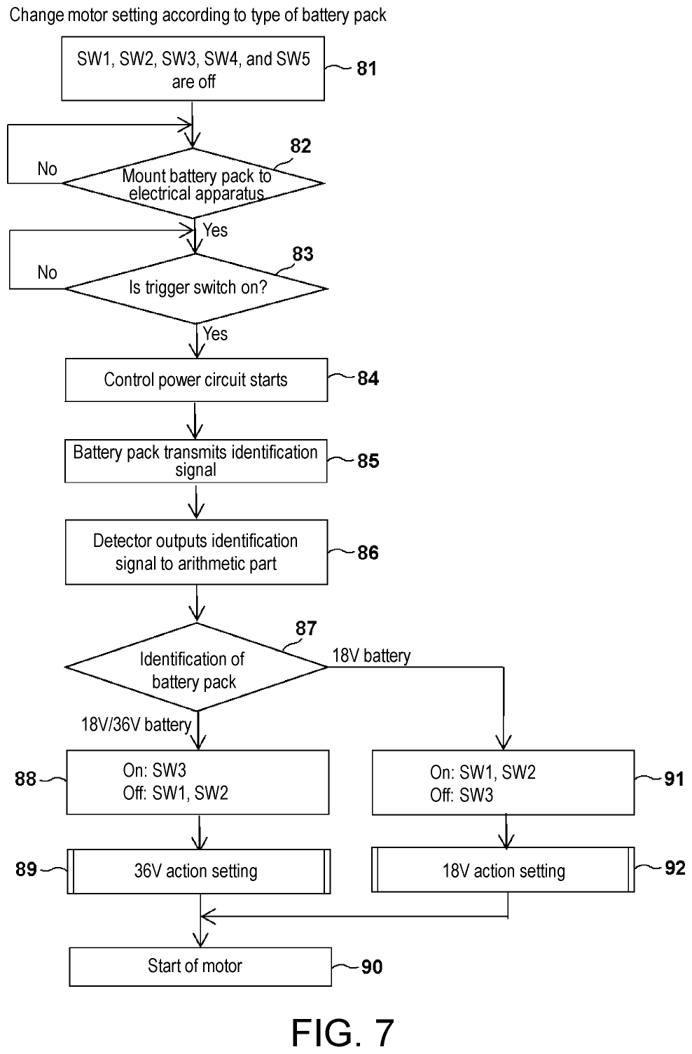

FIG. 7 is a flowchart showing a voltage switching procedure of the electrical apparatus 1 in this embodiment. The series of steps shown in FIG. 7 may be executed by the microcomputer 51 through software execution based on the program stored in the arithmetic part 50 in advance. In the initial state, i.e., in a state in which neither of the battery packs 200 and 250 is mounted, since power cannot be supplied to the arithmetic part 50, the microcomputer remains shut down. In this state, the first to third switches 41 to 43 are all in the off-state (non-conducting state), and the fourth switch 70 and the fifth switch 75 are also all in the off-state (U-phase, V-phase, and W-phase are not connected) (step 81). Next, it is practically determined whether either of the battery packs 200 and 250 is mounted, and if not mounted, it stands by until the battery pack is mounted (step 82). Upon mounting in step 82, the control power circuit 60 (see FIG. 5 and FIG. 6) is supplied with voltage, and the microcomputer 51 of the arithmetic part 50 is brought into a startable state. When the trigger switch 6 is first pulled, the control power circuit 60 starts output of a voltage Vcc for operation to the arithmetic part 50 (steps 83 and 84), so subsequent steps from step 85 become executable.

Next, the battery pack 200 or 250 sends out an identification signal to the detector 44 (see FIG. 5 and FIG. 6). The detector 44 detects the received identification signal and transmits it to the arithmetic part 50 (step 86). Next, the microcomputer 51 distinguishes the identification signal to determine whether the mounted battery pack is the low/high-voltage battery pack 200 of 18V/36V or the single-voltage battery pack 250 of 18V (step 87).

In step 87, if it is determined that the mounted battery pack is the battery pack 200 of 18V/36V, the microcomputer 51 turns on (connects) the third switch 43 and connects the second connection terminal 32 and the first connection terminal 34 by the short-circuit line 37. On the other hand, the first switch 41 and the second switch 42 are maintained in the off-state (step 88). This state is the state shown in the circuit diagram of FIG. 5, and a direct current of 36V is outputted between the positive electrode input terminal 31 and the negative electrode input terminal 33. Next, the microcomputer 51 sets the connection of the motor 5 to 36V action (step 89). Herein, an example of the 36V action setting is setting the connection of the coils of the motor 5 to a star connection as shown in FIG. 5. That is, the switches 71 to 73 of the fourth switch 70 are all turned off and the switches 76 to 78 of the fifth switch 75 are all turned on. After this connection is completed, the microcomputer 51 starts the motor 5 to start the work of the electrical apparatus (step 90).

In step 87, if it is determined that the mounted battery pack is the battery pack 250 of 18V, the microcomputer 51 turns off (disconnects) the third switch 43 to interrupt the path of the short-circuit line 37, and maintains the first switch 41 and the second switch 42 in the on-state (step 91). This state is the state shown in the circuit diagram of FIG. 6, and a direct current of 18V is outputted between the positive electrode input terminal 31 and the negative electrode input terminal 33. Next, the microcomputer 51 sets the connection of the motor 5 to 18V action (step 92). Herein, an example of the 18V action setting is setting the connection of the coils of the motor 5 to a delta connection as shown in FIG. 6. That is, the switches 71 to 73 of the fourth switch 70 are all turned on, and the switches 76 to 78 of the fifth switch 75 are all turned off. After this connection is completed, the microcomputer 51 starts the motor 5 to start the work of the electrical apparatus (step 90).

When the work in step 90 is completed and the trigger switch 6 is switched back, the motor 5 stops, but until the microcomputer 51 is shut down, the states of the first to third switches 41 to 43 set in step 88 or 91 are maintained, and the states of the fourth and fifth switches 70 and 75 set in step 89 or 92 are maintained.

According to this embodiment, the arithmetic part 50 of the electrical apparatus 1 determines the type (low/high-voltage battery pack 200 or single-voltage battery pack 250) of the mounted battery pack and sets the connection of the input terminals (31, 33) and the connection terminals (32, 34) suitable for the type of the mounted battery pack. Thus, in the electrical apparatus having a terminal part shape for 36V, a battery pack for 18V can also be mounted. In addition, the connection configuration (star connection or delta connection) of the coils of the motor 5 is switched according to the voltage of the mounted battery pack 200 or 250, so even in the case where the battery pack 250 of the low-voltage side is mounted, the electrical apparatus 1 can be used without feeling much incongruity. Furthermore, for the user, since it is possible to effectively reuse the owned battery packs 200 and 250, usability is improved.

Further, according to this embodiment, the motor 5 including a plurality of coils is provided, and in the case where a first battery pack (250) is connected to the electrical apparatus 1, the plurality of coils are connected to each other in a first connection configuration (e.g., star connection), and in the case where a second battery pack (200) is connected to the electrical apparatus, the plurality of coils are connected to each other in a second connection configuration (e.g., delta connection) different from the first connection configuration. Thus, it is possible to select an efficient driving method depending on the mounted battery pack. Additionally, it is possible to compensate for the case where only about half the speed of 36V is achieved if the connection configuration is not switched. Furthermore, it is possible to ensure, at 18V, the same rotational speed and torque as at 36V. The rotational speed at the same torque can be increased.

### Embodiment 2

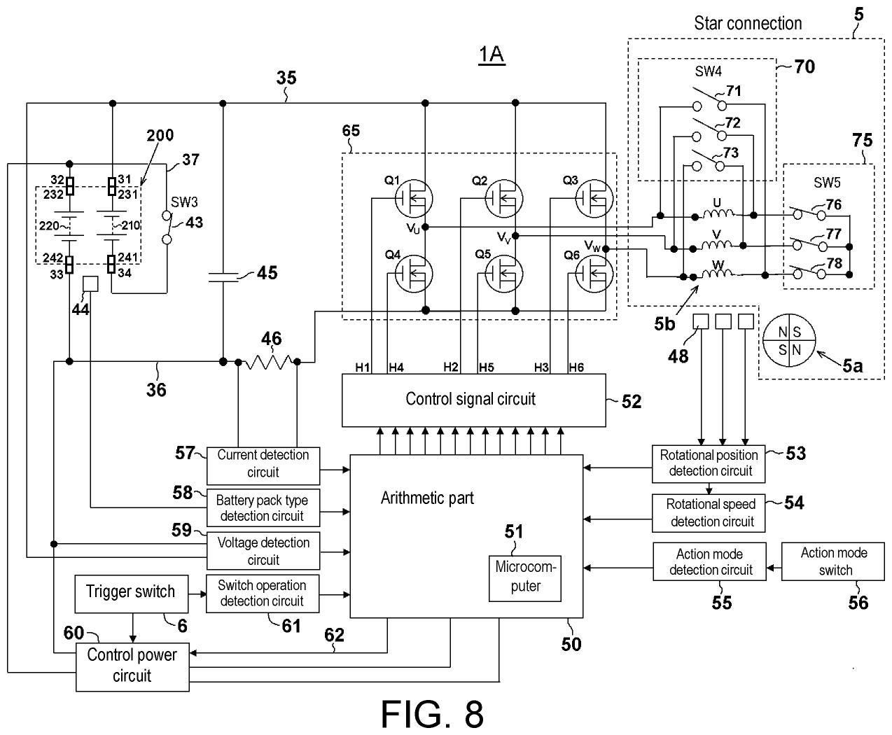

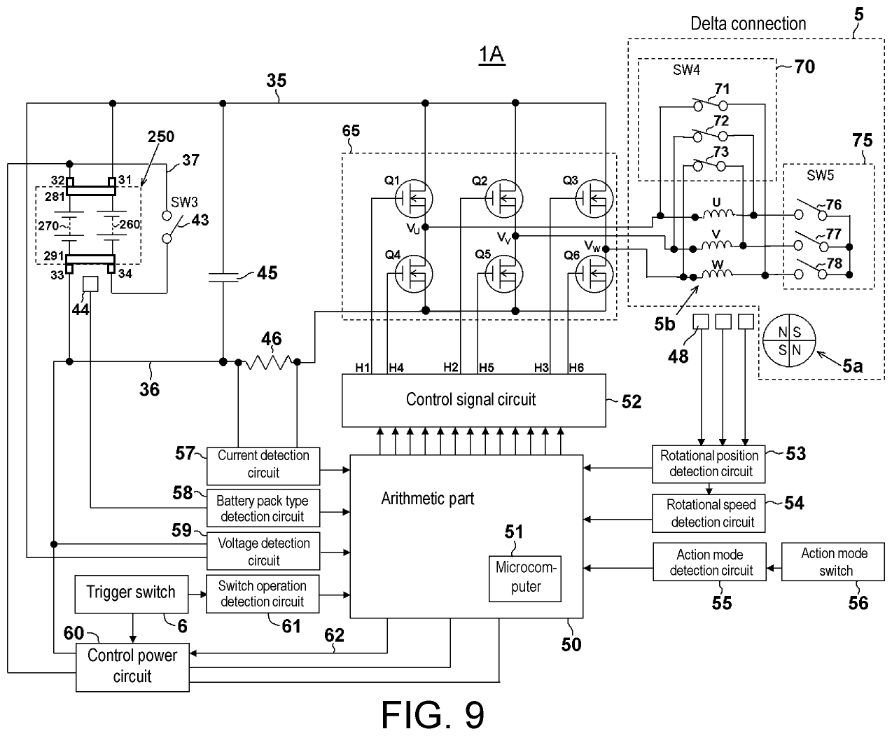

Next, a second embodiment of the present invention will be described with reference to FIG. 8 and FIG. 9. FIG. 8 is a circuit diagram when the low/high-voltage battery pack 200 is mounted to a battery pack mounting part 10 of an electrical apparatus 1A according to the second embodiment of the present invention. The difference from the first embodiment shown in FIG. 5 and FIG. 6 lies in that the first switch 41 (see FIG. 5) and the second switch 42 (see FIG. 5) are omitted from the battery pack mounting part 10 of the electrical apparatus 1A. That is, since the portion of the first and second switches 41 and 42 (see FIG. 5) is not connected in the first embodiment, the second connection terminal 32 and the power line 35 are not directly connected, and the first connection terminal 34 and the ground line 36 are not directly connected. Except for the absence of the first and second switches 41 and 42 (see FIG. 5), the other components are the same as in the first embodiment. The switching method between a star connection and a delta connection of the motor 5 is also controlled in the same manner using the fourth switch 70 and the fifth switch 75. In the case where the low/high voltage battery pack 200 is mounted to the battery pack mounting part 10 of the electrical apparatus 1A, by turning on the third switch 43 to bring the short-circuit line 37 into a connected state, a direct current of 36V is outputted between the positive electrode input terminal 31 and the negative electrode input terminal 33. At this time, the switches 71 to 73 of the fourth switch 70 are all turned off, and the switches 76 to 78 of the fifth switch 75 are all turned on to set the motor 5 to a star connection.

FIG. 9 is a circuit diagram when the low-voltage battery pack 250 is mounted to the battery pack mounting part 10 of the electrical apparatus 1A according to the second embodiment of this embodiment. When the low-voltage battery pack 250 is mounted, based on the shapes of the third positive electrode terminal 281 and the third negative electrode terminal 291 (refer to (B) of FIG. 4 together), the positive electrode input terminal 31 and the second connection terminal 32 are short-circuited, and the negative electrode input terminal 33 and the first connection terminal 34 are short-circuited. Furthermore, if the microcomputer 51 determines that the mounted battery pack 250 is 18V according to the output of the battery pack type detection circuit 58, the third switch 43 is maintained in the off-state. In addition, the microcomputer 51 turns on all the switches 71 to 73 of the fourth switch 70 and turns off all the switches 76 to 78 of the fifth switch 75 to set the motor 5 to a delta connection.

A voltage switching procedure of the electrical apparatus 1A according to the second embodiment is almost the same as the flowchart shown in FIG. 7. The only difference lies in that the control on the first switch 41 and the second switch 42 is not required in steps 88 and 91. In the second embodiment, since the first switch 41 and the second switch 42 may be omitted, the quantity of the switches arranged in the housing 2 of the electrical apparatus 1A can be reduced to suppress an increase in the size of the housing 2.

### Embodiment 3

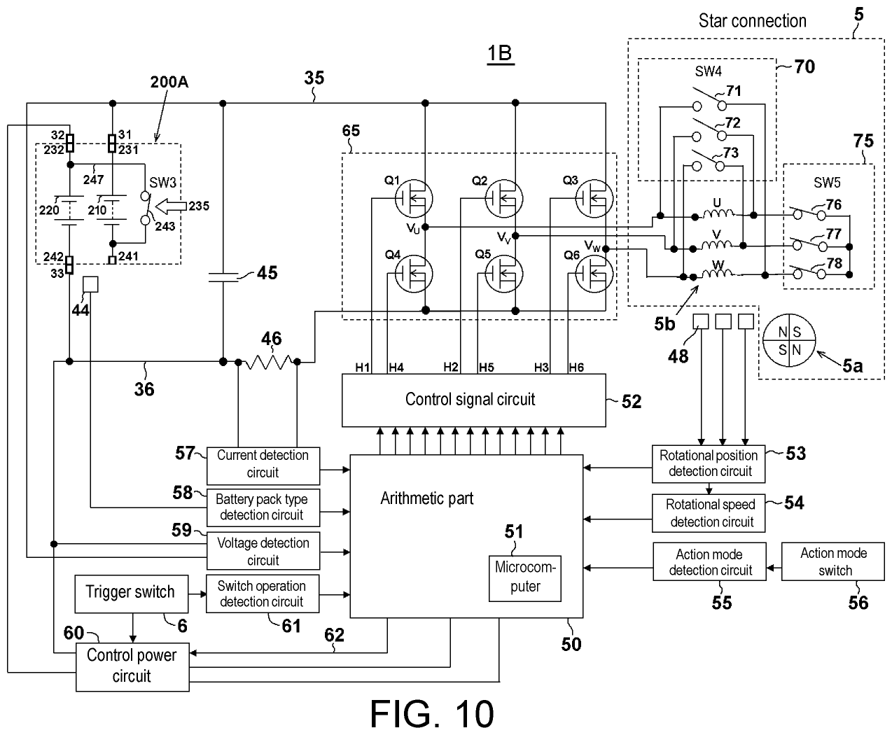

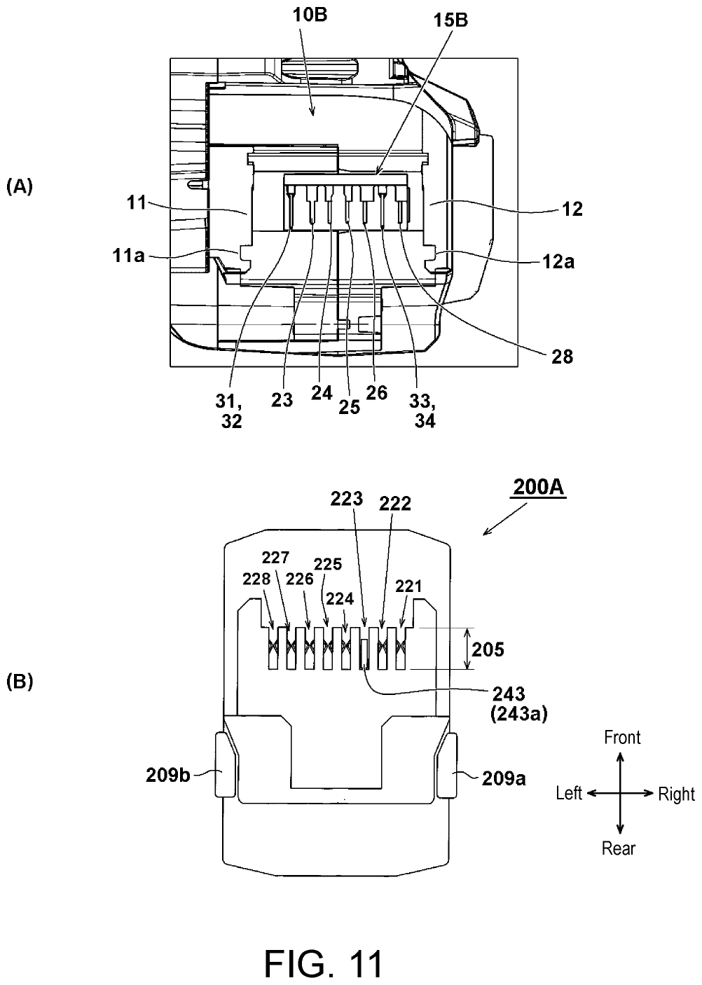

FIG. 10 is a circuit diagram when a low/high-voltage battery pack 200A is mounted to a battery pack mounting part 10 of an electrical apparatus 1B according to a third embodiment of this embodiment. Similar to the low/high-voltage battery pack 200 shown in FIG. 5, the battery pack 200A of 18V/36V includes, as positive electrode side terminals of the battery pack 200A, a first positive electrode terminal 231 with an arm located on the upper side and a second positive electrode terminal 232 with an arm located on the lower side. Similarly, a second negative electrode terminal 242 with an arm located on the upper side and a first negative electrode terminal 241 with an arm located on the lower side are provided. At a compatible electrical apparatus 1, a positive electrode input terminal 31, a negative electrode input terminal 33, and a second connection terminal 32 are provided. However, a terminal corresponding to the first connection terminal 34 shown in FIG. 5 is omitted.

In the third embodiment, a short-circuit line 247 is provided in the housing of the battery pack 200A of 18V/36V, and a third switch 243 is provided in the path of the short-circuit line 247. A switch movable piece is physically moved from outside of the case 201 (see FIG. 2) to control “on” or “off” of the third switch 243. Herein, a pressing piece 23 (to be described later in FIG. 11) provided on the battery pack mounting part 10 side of the electrical apparatus 1B biases a movable piece 243a (to be described later in FIG. 11) of the third switch 243 in a direction indicated by an arrow 235 to turn on the third switch 243. Further, upon mounting of the battery pack 200A, since the microcomputer 51 can determine, via the detector 44, that the battery pack 200A is a model capable of 36V output, the fourth switch 70 is all turned off and the fifth switch 75 is all turned on to set the coils of the motor 5 to a star connection. Next, the shapes of the pressing piece 23 provided at the battery pack mounting part 10 of the electrical apparatus 1B and the third switch 243 will be described with reference to FIG. 11.

(A) of FIG. 11 is a bottom view of a battery pack mounting part 10B of the electrical apparatus 1B shown in FIG. 10. In the battery pack mounting part 10B, a positive electrode input terminal 31 and a second connection terminal 32 shown in FIG. 4 are arranged with a distance therebetween in the up-down direction (appearing to overlap in the figure), and a negative electrode input terminal 33 and a first connection terminal 34 are arranged with a distance therebetween in the up-down direction (appearing to overlap in the figure). Terminals for communication including a T terminal 24, a V terminal 25, and an LS terminal 26 are provided between the first connection terminal 34 and the second connection terminal 32, and an LD terminal 28 is provided next to the first connection terminal 34. The pressing piece 23 for pressing the third switch 243 is provided between the second connection terminal 32 and the T terminal 24. The position at which the pressing piece 23 is provided, i.e., a slot 223 in (B) of FIG. 11, would be a spare space where no connection terminal is provided in a conventional 18V battery pack or a conventional 18V/36V battery pack. Thus, in the third embodiment, the pressing piece 23 made of a non-conductor such as synthetic resin is provided in the spare space, and when the battery pack 200 is mounted to the battery pack mounting part 10B, the pressing piece 23 presses the third switch 243 arranged in the corresponding slot 223.

(B) of FIG. 11 is a schematic view of a top surface of the low/high-voltage battery pack 200A. The shape of the battery pack 200A differs from that of the low/high-voltage battery pack 200 in the structure that the third switch 243 is arranged inside the slot 223. Eight slots 221 to 228 are arranged sequentially from the right side in a slot group 205 of the battery pack 200A. The slot 222 is a slot for a positive electrode, and the first positive electrode terminal 231 and the second positive electrode terminal 232 shown in FIG. 4 are arranged in the internal space of the slot 222. The slot 227 is a slot for a negative electrode, and the first negative electrode terminal 241 and the second negative electrode terminal 242 shown in FIG. 4 are arranged in the internal space of the slot 227. Upon moving the battery pack 200A to mount to the battery pack mounting part 10B shown in (A) of FIG. 11, the positive electrode input terminal 31 and the second connection terminal 32 are inserted into the slot 222 and fitted with the first positive electrode terminal 231 and the second positive electrode terminal 232. Also, the negative electrode input terminal 33 and the first connection terminal 34 are inserted into the slot 227 and fitted with the second negative electrode terminal 242 and the first negative electrode terminal 241. In addition, terminals 24 to 26 and 28 for communication are also inserted respectively into the slots 224 to 226 and 228 and fitted with the communication terminals on the battery pack 200A side.

The pressing piece 23 formed at the battery pack mounting part 10B of the electrical apparatus 1B is inserted into the slot 223 and presses and moves a mover 243a of the third switch 243 to switch the third switch 243 from the off-state to the on-state. That is, since the protrusion (pressing piece 23) of the battery pack mounting part 10B of the electrical apparatus 1B operates the third switch 243 provided in the empty slot 223 on the battery pack 200A side, the third switch 243 is automatically operated. In this manner, upon mounting of the dual-voltage battery pack 200A for 18V/36V, the third switch 243 is forcibly brought into the on-state, i.e., a connected state as shown in the circuit diagram of FIG. 10. Upon removal of the battery pack 200A from the battery pack mounting part 10B of the electrical apparatus 1B, since the pressing piece 23 which has been pressed is separated from the third switch 243, the movable piece (mover 243a) of the third switch 243 returns to its original position (initial position) by the action of a spring (not shown) to bring the third switch 243 into the off-state.

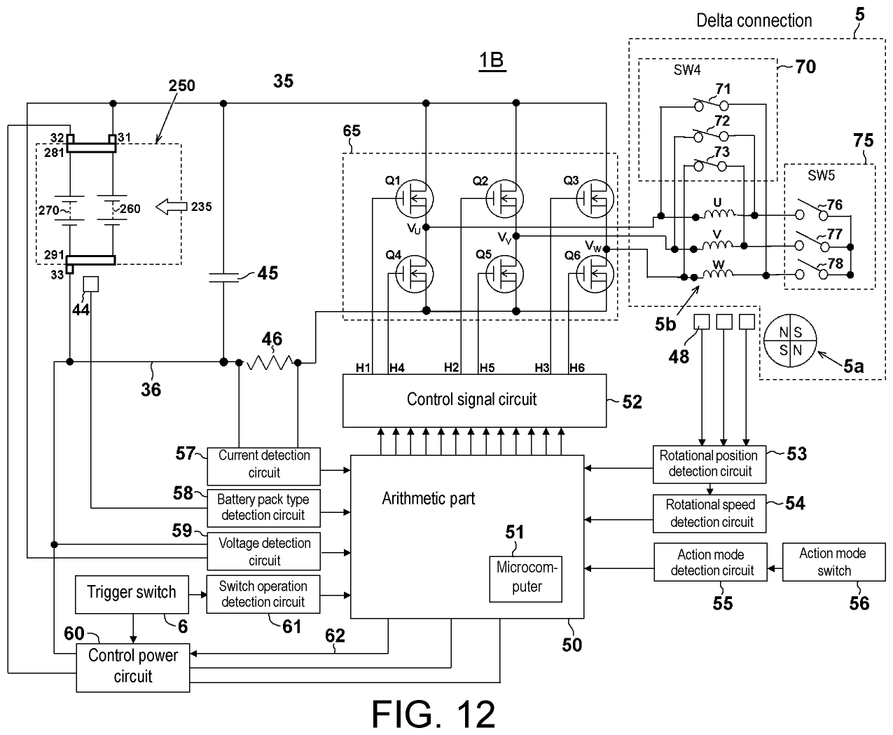

FIG. 12 is a circuit diagram when the battery pack 250 of 18V is mounted to the battery pack mounting part 10B of the electrical apparatus 1B according to the third embodiment of this embodiment. The external shapes of the terminal part and the rail parts of the battery pack 250 of 18V are the same (compatible) as the appearance of the battery pack 200A shown in (B) of FIG. 11. The third positive electrode terminal 281 shown in (B) of FIG. 4 is arranged at a position corresponding to the slot 222 in (B) of FIG. 11, and the third negative electrode terminal 291 shown in (B) of FIG. 4 is arranged at a position corresponding to the slot 227 in (B) of FIG. 11. However, a switch corresponding to the third switch 243 (see FIG. 10) is not provided inside the battery pack 250 of 18V, and the internal space at the position corresponding to the slot 223 in (B) of FIG. 11 is empty. Thus, even if the battery pack 250 is mounted to the battery pack mounting part 10B of the electrical apparatus 1B, only the pressing piece 23 as a non-conductor is inserted into the empty slot 223 as indicated by an arrow 235, and there is no change in the circuit configuration on the battery pack 250 side.

The battery pack 250 includes a third positive electrode terminal 281 and a third negative electrode terminal 291. The third positive electrode terminal 281 is fitted to the positive electrode input terminal 31 and the second connection terminal 32, and the third negative electrode terminal 291 is fitted to the negative electrode input terminal 33. As a result, as shown in FIG. 12, a direct current of 18V is outputted between the power line 35 and the ground line 36. Further, upon mounting of the battery pack 250, since the microcomputer 51 can determine, via the detector 44, that the battery pack 250 is a model capable of 18V output, the fourth switch 70 is all turned on and the fifth switch 75 is all turned off to set the coils of the motor 5 to a delta connection.

In the third embodiment, a short-circuit line 247 for connecting two cell units 210 and 220 in series is arranged inside the battery pack 200A. Since an operating member (pressing piece 23) for operating the third switch 243 arranged inside the battery pack 200A is provided at the battery pack mounting part 10B of the electrical apparatus 1B, the output of the battery pack 200A can be automatically switched to the high output side by simply mounting the battery pack 200A to the battery pack mounting part 10B of the electrical apparatus 1B attached with the pressing piece 23.

In the first to third embodiments, when the high-voltage (36V) battery pack is mounted to the battery pack mounting part 10 or 10B, the motor 5 is set to a star connection, and when the low-voltage (18V) battery pack is mounted, the motor 5 is set to a delta connection. However, other methods may also be considered to switch the control on the motor 5 between rotation control optimal for high-voltage driving and rotation control optimal for low-voltage driving.

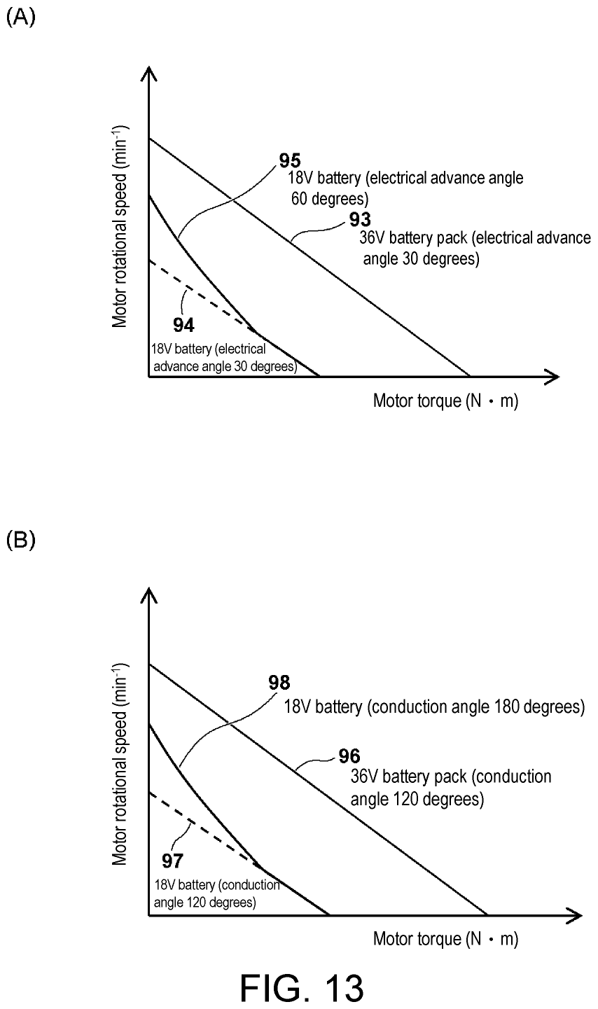

FIG. 13 is a view showing a switching example of control characteristics of the motor, and (A) of FIG. 13 is a view showing a relationship between the motor rotational speed and the motor torque in the case where an electrical advance angle is changed. Herein, the electrical advance angle will be described. An electrical advance angle 0 degrees refers to the case where “on-off” of the semiconductor switching elements Q1 to Q6 of the inverter circuit 65 is switched at the moment the signal outputted from the position detection element (Hall IC) 48 to the arithmetic part 50 (microcomputer 51) via the rotational position detection circuit 53 switches from on to off or from off to on. An electrical advance angle 30 degrees (15 degrees×2 (in the case of a four-pole rotor) refers to the case where “on-off” of the semiconductor switching elements Q1 to Q6 of the inverter circuit 65 is switched at a timing at which the rotor 5a is at a rotational angle 15 degrees before the above-described timing. In the figure, the vertical axis represents the rotational speed (unit: min⁻¹) of the motor 5, and the horizontal axis represents the generated torque (unit: N-m) of the motor 5. A characteristic 93 is a characteristic of the motor rotational speed and the motor torque in the case where the motor 5 is driven at 36V and the electrical advance angle is driven at 30 degrees in the electrical apparatus 1 compatible with 18V/36V. It has a characteristic that the motor rotational speed decreases linearly as the motor torque increases. In the motor 5 of such a characteristic, when the same motor 5 is driven with a power of 18V, since the characteristic becomes a characteristic 94 as indicated by a dotted line, the motor rotational speed and the motor torque both decrease. Thus, by switching the “on-off” of the semiconductor switching elements Q1 to Q6 of the inverter circuit 65 at a rotational angle 30 degrees of the rotor 5a in advance (electrical advance angle of 30×2 (in the case of a 4-pole rotor)=60 degrees) with respect to the timing of the electrical advance angle 0 degrees, and changing the electrical advance angle from 30 degrees to 60 degrees even with the power of 18V, it is possible to significantly increase the motor rotational speed in the low torque region as indicated by a characteristic 95. Thus, by increasing the electrical advance angle when the 18V battery pack 250 is mounted to the electrical apparatus 1, it is possible to approach the rotation characteristic of 36V action.

(B) of FIG. 13 is a view showing a relationship between the motor rotational speed and the motor torque in the case where the conduction angle is changed. Herein, the conduction angle will be described. Since “on-off” of the semiconductor switching elements Q1 to Q6 of the inverter circuit 65 is switched according to the position of the rotor 5a (output of the position detection element 48), “on-off” of conduction of the current flowing through each stator coil (U-phase, V-phase, and W-phase) and the flowing direction (forward direction and reverse direction) of the current also change. 120-degree conduction refers to turning on and off the semiconductor switching elements Q1 to Q6 of the inverter circuit 65 such that “on-off” of conduction of each stator coil and the flowing direction of the current do not change until the rotor 5a rotates 60 degrees (conduction angle of 60 degrees×2 (in the case of a four-pole rotor)=120 degrees). A characteristic 96 is a characteristic of the motor rotational speed and the motor torque in the case where the motor 5 is driven at 36V and the conduction angle is driven at 120 degrees in the electrical apparatus 1 compatible with 18V/36V. It has a characteristic that the motor rotational speed decreases linearly as the motor torque increases. In the motor 5 with such a characteristic, when the same motor 5 is driven with a power of 18V, since the characteristic becomes a characteristic 97 as indicated by a dotted line, the motor rotational speed and the motor torque both decrease. Thus, by turning on and off the semiconductor switching elements Q1 to Q6 of the inverter circuit 65 such that “on-off” of conduction of each stator coil and the flowing direction of the current do not change until the rotor 5a rotates 90 degrees (conduction angle of 90 degrees×2 (in the case of a four-pole rotor)=180 degrees), and changing the conduction angle from 120 degrees to 180 degrees even with the power of 18V, the motor rotational speed in the low torque region can be significantly increased as indicated by a characteristic 98. Thus, by increasing the conduction angle when the 18V battery pack 250 is mounted to the electrical apparatus 1, it is possible to approach the rotation characteristic of 36V action.

The present invention has been described based on the embodiments, but the present invention is not limited to the above embodiments, and various modifications are possible within the scope of the spirit of the present invention.

### REFERENCE SIGNS LIST

1, 1A, 1B . . . Electrical apparatus; 2 . . . Housing; 2a . . . Main body part; 2b . . . Handle part; 2c . . . Saw cover; 3 . . . Base; 3a . . . Cutout part; 4 . . . Motor cover; 5 . . . Motor; 5a . . . Rotor; 5b . . . Stator; 6 . . . Trigger switch; 8 . . . Saw blade; 9 . . . Protective cover; 10, 10B . . . Battery pack mounting part; 11, 12 . . . Rail part; 11a, 11b . . . Recess; 15 . . . Terminal part; 23 . . . Pressing piece; 24 . . . T terminal; 25 . . . V terminal; 26 . . . LS terminal; 28 . . . LD terminal; 30 . . . Partition plate; 31 . . . Positive electrode input terminal; 32 . . . Second connection terminal; 33 . . . Negative electrode input terminal; 34 . . . First connection terminal; 35 . . . Power line (positive power line); 36 . . . Power line (ground line); 37 . . . Short-circuit line; 41 . . . First switch; 42 . . . Second switch; 43 . . . Third switch; 44 . . . Detector; 45 . . . Capacitor; 46 . . . Shunt resistor; 48 . . . Position detection element; 50 . . . Arithmetic part; 51 . . . Microcomputer; 52 . . . Control signal circuit; 53 . . . Rotational position detection circuit; 54 . . . Rotational speed detection circuit; 55 . . . Action mode detection circuit; 56 . . . Action mode switch; 57 . . . Current detection circuit; 58 . . . Battery pack type detection circuit; 59 . . . Voltage detection circuit; 60 . . . Control power circuit; 61 . . . Switch operation detection circuit; 62 . . . Start maintenance signal; 65 . . . Inverter circuit; 70 . . . Fourth switch; 71 to 73 . . . Switch; 75 . . . Fifth switch; 76 to 78 . . . Switch; 101 . . . Electrical apparatus; 110 . . . Battery pack mounting part; 151 . . . Electrical apparatus; 160 . . . Battery pack mounting part; 200, 200A . . . Battery pack (low/high voltage battery pack, first battery pack); 201 . . . Case; 202 . . . Lower-step surface; 203 . . . Step part; 204 . . . Upper-step surface; 205 . . . Slot group; 207 . . . Stopper part; 208a, 208b . . . Rail groove; 209a, 209b . . . Latch button; 210 . . . First cell unit; 220 . . . Second cell unit; 221 to 228 . . . Slot; 231 . . . First positive electrode terminal; 231a, 231b . . . Arm; 232 . . . Second positive electrode terminal; 232a, 232b . . . Arm; 241 . . . First negative electrode terminal; 241a, 241b . . . Arm; 242 . . . Second negative electrode terminal; 242a, 242b . . . Arm; 243 . . . Third switch; 243a . . . Mover; 247 . . . Short-circuit line; 250 . . . Battery pack (low-voltage battery pack, second battery pack); 251 . . . Case; 252 . . . Lower-step surface; 253 . . . Step part; 254 . . . Upper-step surface; 255 . . . Slot group; 258a . . . Rail groove; 259a . . . Latch button; 260 . . . Third cell unit; 270 . . . Fourth cell unit; 281 . . . Third positive electrode terminal; 281a, 281b . . . Arm; 291 . . . Third negative electrode terminal; 291a, 291b . . . Arm; Q1 to Q6 . . . Switching element; Vcc . . . Reference voltage.

1. An electrical apparatus comprising an electrical apparatus main body alternatively connectable to a first battery pack capable of selectively outputting a high voltage or a low voltage and a second battery pack capable of outputting only the low voltage, wherein
the high voltage is supplied from the first battery pack to the electrical apparatus main body in a case where the first battery pack is connected to the electrical apparatus main body, and the low voltage is supplied from the second battery pack to the electrical apparatus main body in a case where the second battery pack is connected to the electrical apparatus main body.

2. The electrical apparatus according to claim 1, comprising a voltage switching part which switches a voltage supplied from a battery pack to the electrical apparatus main body, wherein
the voltage switching part is configured to switch the voltage supplied to the electrical apparatus main body from the first battery pack to the high voltage in a case where the first battery pack is connected to the electrical apparatus main body.

3. The electrical apparatus according to claim 2, wherein the voltage switching part is configured to maintain the voltage supplied to the electrical apparatus main body from the second battery pack at the low voltage in a case where the second battery pack is connected to the electrical apparatus main body.

4. The electrical apparatus according to claim 3, wherein the voltage switching part is configured such that a plurality of cells included in the first battery pack are connected to each other via the voltage switching part, and a plurality of cells included in the second battery pack are not connected to each other via the voltage switching part.

5. The electrical apparatus according to claim 4, wherein the voltage switching part comprises a first switch part configured to be capable of connecting the plurality of cells included in the first battery pack to each other, and
the first switch part is turned on in a case where the first battery pack is connected to the electrical apparatus main body and is turned off in a case where the second battery pack is connected to the electrical apparatus main body.

6. The electrical apparatus according to claim 1, comprising a motor having a plurality of coils, wherein
the electrical apparatus connects the plurality of coils to each other in a first connection configuration in a case where the first battery pack is connected to the electrical apparatus main body, and connects the plurality of coils to each other in a second connection configuration different from the first connection configuration in a case where the second battery pack is connected to the electrical apparatus main body.

7. The electrical apparatus according to claim 6, wherein the first connection configuration is suitable for high voltage driving and the second connection configuration is suitable for low voltage driving.

8. The electrical apparatus according to claim 6, wherein in a case where a same voltage is applied to the motor, comparing the first connection configuration and the second connection configuration, the second connection configuration allows a large current to flow more easily.

9. The electrical apparatus according to claim 1, wherein
the first battery pack comprises: a first cell unit and a second cell unit; a first positive electrode terminal connected to a positive electrode of the first cell unit; a first negative electrode terminal connected to a negative electrode of the first cell unit; a second positive electrode terminal connected to a positive electrode of the second cell unit; and a second negative electrode terminal connected to a negative electrode of the second cell unit,
the second battery pack comprises: a third cell unit included in at least one cell unit; a third positive electrode terminal connected to a positive electrode of the third cell unit; and a third negative electrode terminal connected to a negative electrode of the third cell unit,
the electrical apparatus main body comprises: a positive electrode input terminal connectable to the first positive electrode terminal and the third positive electrode terminal; a negative electrode input terminal connectable to the second negative electrode terminal and the third negative electrode terminal; a first connection terminal connectable to the first negative electrode terminal; a second connection terminal connectable to the second positive electrode terminal; a connection part connecting the first connection terminal and the second connection terminal to each other; and a load part connected to the positive electrode input terminal and the negative electrode input terminal,
in a case where the first battery pack is connected to the electrical apparatus main body, the first positive electrode terminal is connected to the positive electrode input terminal, the second negative electrode terminal is connected to the negative electrode input terminal, the first negative electrode terminal is connected to the first connection terminal, the second positive electrode terminal is connected to the second connection terminal, and power is supplied from the first battery pack to the load part in a state in which the first cell unit and the second cell unit are connected in series to each other via the connection part, and
in a case where the second battery pack is connected to the electrical apparatus main body, the third positive electrode terminal is connected to the positive electrode input terminal, the third negative electrode terminal is connected to the negative electrode input terminal, and power is supplied from the second battery pack to the load part.

10. The electrical apparatus according to claim 5, comprising a control part connected to the first switch part, wherein
the control part is configured to switch on and off the first switch part depending on a battery pack connected.

11. The electrical apparatus according to claim 1, comprising:
a second switch part provided between the first negative electrode terminal and a ground line; and
a third switch part provided between the second positive electrode terminal and a positive power line, wherein
the control part disconnects the second switch part and the third switch part in a case where the first battery pack is connected, and connects the second switch part and the third switch part in a case where the second battery pack is connected.

12. An electrical apparatus comprising an electrical apparatus main body alternatively connectable to a first battery pack capable of selectively outputting a high voltage or a low voltage and a second battery pack capable of outputting only the low voltage,
the electrical apparatus main body comprising a motor having a plurality of coils, wherein
the plurality of coils are connected to each other in a first connection configuration in a case where the first battery pack is connected to the electrical apparatus main body, and the plurality of coils are connected to each other in a second connection configuration different from the first connection configuration in a case where the second battery pack is connected to the electrical apparatus main body.

13. The electrical apparatus according to claim 12, wherein the first connection configuration is a star connection of the plurality of coils, and the second connection configuration is a delta connection of the plurality of coils.

14. The electrical apparatus according to claim 1, comprising at least one of the first battery pack and the second battery pack.

15. An electrical apparatus comprising an electrical apparatus main body alternatively connectable to a first battery pack and a second battery pack different from the first battery pack,
the electrical apparatus main body comprising a motor having a plurality of coils, wherein
the plurality of coils are connected to each other in a first connection configuration in a case where the first battery pack is connected to the electrical apparatus main body, and the plurality of coils are connected to each other in a second connection configuration different from the first connection configuration in a case where the second battery pack is connected to the electrical apparatus main body.

16. The electrical apparatus according to claim 12, comprising at least one of the first battery pack and the second battery pack.

17. The electrical apparatus according to claim 15, comprising at least one of the first battery pack and the second battery pack.
